(19) United States
(12) Patent Application Publication
(10) Pub. No.: US 2005/0163423 A1
(43) Pub. Date: Jul. 28, 2005

(54) Optical filter assembly and method

(76) Inventors: Jianhua Wang, Saratoga, CA (US); Lixuan Xu, San Leandro, CA (US)

Correspondence Address: Billy Lau, 486 Vista Del Norte, Walnut, CA, 91789-1605, US

(21) Appl. No.: 11/041,688

(22) Filed: Jan. 23, 2005

Related U.S. Application Data
(60) Provisional application No. 60/538,931, filed on Jan. 24, 2004.

(51) Int. Cl. G02B 6/32

(52) U.S. Cl. 385/33

(57) ABSTRACT

According to an embodiment of the present invention an optical filter assembly suitable for use in, for example, an optical fiber system, comprises a focusing lens, a first holder holding the focusing lens; and an optical filter having a reflective surface attaching to the first holder optically coupling with the focusing lens. A method for fabricating an embodiment comprises positioning and securing the focusing lens and the optical filter on a first holder at predetermined positions. For setting the embodiment within a predetermined center wavelength range measured under a measurement condition, the method for fabricating the embodiment further comprises selecting an optical filter from a group of one or more optical filters of different center wavelengths and a focusing lens from a group of one or more focusing lenses of different focal length such that the selection will result in an embodiment that satisfies the center wavelength range requirement.

### CROSS-REFERENCE TO RELATED APPLICATION

This application is related to Provisional Patent Application Ser. No. 60/538,931 filed on Jan. 24, 2004, which is incorporated by reference herein.

### FIELD OF THE INVENTION

This invention generally relates to optical fiber technology. Particularly, this invention relates to an optical filter assembly suitable for use in, for example, an optical fiber system.

### BACKGROUND OF THE INVENTION

Optical filters, including for example thin film filters, are commonly employed in an optical fiber system. Particularly, in a wavelength division multiplexing optical fiber system, thin film filters are commonly employed to multiplex and demultiplex optical signals. Common optical filters include edge-pass optical filters and bandpass optical filters. There are two types of edge-pass optical filters, shortpass optical filters and longpass optical filters. A characteristic of an edge-pass optical filter is the cutoff wavelength. The cutoff wavelength may be interpreted as the center wavelength of the edge of the edge-pass filter. The passband wavelengths of a shortpass optical filter are shorter than the cutoff wavelength and the stopband wavelengths of the shortpass optical filter are longer than the cutoff wavelength. The passband wavelengths of a longpass optical filter are longer than the cutoff wavelength and the stopband wavelengths of the longpass optical filter are shorter than the cutoff wavelength. A characteristic of a bandpass optical filter is the center wavelength. The center wavelength of a bandpass filter is the center wavelength of the passband. Throughout this specification, when referring to an edge-pass optical filter, the center wavelength means the cutoff wavelength of the edge-pass optical filter. When referring to a bandpass optical filter, the center wavelength means the center wavelength of the passband. Many optical filters, including thin film filters, substantially allow light with wavelengths in its passband to pass through and substantially reflect light with wavelengths in its stopband.

For wavelength division multiplexing optical fiber system applications, it is desirable that the optical filter employed in the system has a highly accurate center wavelength. Unfortunately, the production yield of many types of optical filters, including for example thin film filters, is relatively low at the center wavelength accuracy required by a typical wavelength division multiplexing optical fiber system. To improve production yield of an optical apparatus, including for example those that are suitable for wavelength division multiplexing optical fiber system applications, it is desirable to provide an optical filter assembly that comprises an optical filter, in which, the center wavelength tolerance of the optical filter assembly is different from the center wavelength tolerance of the optical filter employed in the optical filter assembly. Preferably, the center wavelength tolerance of the optical filter assembly is tighter than the center wavelength tolerance of the optical filter employed in the optical filter assembly.

### SUMMARY OF THE INVENTION

According to an embodiment of the present invention an optical filter assembly suitable for use in, for example, an optical fiber system comprises a focusing lens, a first holder holding the focusing lens substantially at a predetermined position with respect to the first holder; and an optical filter having a reflective surface directly or indirectly attaching to the first holder optically coupling with the focusing lens. A method for fabricating an embodiment comprises positioning and securing the focusing lens and the optical filter on a first holder at predetermined positions. For setting the embodiment within a predetermined center wavelength range requirement measured under a predetermined measurement condition, the method for fabricating the embodiment further comprises selecting an optical filter from a group of one or more optical filters of different center wavelengths and a focusing lens from a group of one or more focusing lenses of different focal length such that the selection will result in an embodiment that satisfies the predetermined center wavelength range requirement.

### DESCRIPTION OF THE DRAWINGS

A better understanding of the invention may be gained from the consideration of the following detailed descriptions taken in conjunction with the accompanying drawings in which:

FIG. 1 shows a schematic view of an embodiment of the present invention.

FIG. 2 shows a schematic view of the embodiment shown in FIG. 1 with an optical fiber interface.

FIG. 3 shows the schematic of an alternative embodiment according to the present invention.

FIG. 4 is a sectional view of a representative first holder, which is employed in the embodiment shown in FIG. 3.

FIG. 5 shows the schematic of another alternative embodiment according to the present invention.

### DETAILED DESCRIPTION OF THE INVENTION

In the description that follows, like parts are indicated throughout the specification and drawings with the same reference numerals. The present invention is not limited to the specific embodiments illustrated herein.

One skilled in the art understands that the center wavelength of many types of optical filters, including for example thin film filters, is a function of the incident angle of the light incident to the optical filter. This function varies with the optical filter design, and this function is well understood for numerous types of optical filter designs. Consequently, the industry typically specifies the center wavelength of an optical filter at a selected incident angle. An embodiment of the present invention comprises an optical filter and a focusing lens. According to the embodiment, by selecting a combination of the center wavelength of the optical filter and the focal length of the focusing lens employed, the center wavelength of the embodiment measured under a predetermined measurement condition can be shifted to another wavelength; preferably a desirable wavelength. One skilled in the art readily understands changing the measurement condition, including for example, the distance between the incident light and the optical axis of focusing lens 101, may change the center wavelength of the embodiment.

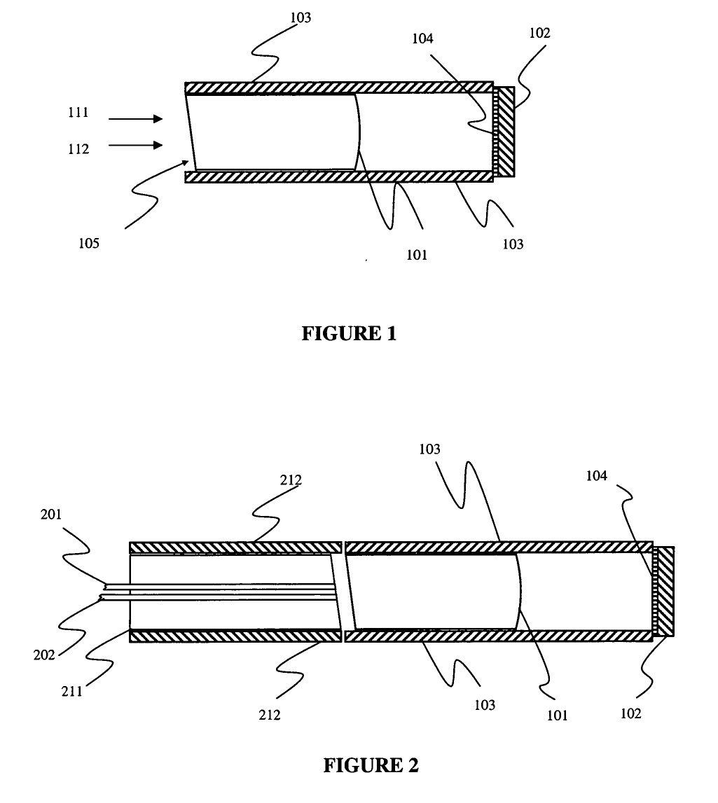

FIG. 1 shows a schematic view of an embodiment of the present invention. Referring to FIG. 1, optical filter 102 has a reflective surface 104. Reflective surface 104 is facing focusing lens 101. Reflective surface 104 substantially reflects light with wavelengths in the stopband of optical filter 102. Optionally, reflective surface 104 substantially allows light with wavelengths in the passband of optical filter 102 to pass through. Optical filter 102 is disposed in the embodiment such that reflective surface 104 is substantially on the focal plane of the plano-convex type focusing lens 101 depicted in FIG. 1. One skilled in the art readily understands that the distance between focusing lens 101 and reflective surface 104 of the embodiments may change with the type of focusing lens employed and the orientation of optical filter 102. Further reflective surface 104 is substantially perpendicular to optical axis of focusing lens 101. Light propagates from input port 111 through focusing lens 101 and comes to focus substantially at reflective surface 104 of optical filter 102 and is at an incident angle relative to reflective surface 104. This incident angle primarily depends on two factors: the position of input port 111 with respect to the optical axis of focusing lens 101 and the focal length of focusing lens 101. Larger distance between input port 111 and the optical axis of focusing lens 101, or shorter focal length of focusing lens 101, or both will result in larger incident angle. Light reflected by reflective surface 104 propagates through focusing lens 101 to output port 112. One skill in the art readily understands that in the embodiment shown in Figure, the functional area of reflective surface 104 occupies a relative small region about the intersection of the optical axis of focusing lens 101 and reflective surface 104.

In the arrangement shown in FIG. 2, the embodiment shown in FIG. 1 optically couples with a multiple optical fiber interface that includes an input optical fiber 201 terminated at input port 111, as identified in FIG. 1, and an output optical fiber 202 terminated at output port 112, as identified in FIG. 1. The separation between input optical fiber 201 and output optical fiber 202 in fiber ferrule 211 defines a distance between input port 111 and the optical axis of focusing lens 101. Therefore, in the arrangement shown in FIG. 2, the incident angle depends on the focal length of focusing lens 101, and the separation between the termination of input optical fiber 201 and the termination of output optical fiber 202 that are in the proximity of focusing lens 101. In the proximity of focusing lens 101, fiber ferrule 211 holds the termination of input optical fiber 201 and the termination of output optical fiber 202 in position. Ferrule holder 212 houses fiber ferrule 211. Ferrule holder 212 attaches to first holder 103. Representative methods of attaching ferrule holder 212 to first holder 103 include, for example, attaching with an adhesive such as an epoxy or soldering.

Referring again to FIG. 1, focusing lens 101 is a plano-convex lens. First holder 103 holds focusing lens 101 in position, including the angular orientation of the optical axis of focusing lens 101. Representative methods for attaching focusing lens 101 to first holder 103 include, for example, applying an adhesive, soldering, or press fitting. Optionally, the plano surface end of focusing lens 101 is in alignment with an end of first holder 103. The normal to the plano surface of focusing lens 101 is at an angle to the optical axis of focusing lens 101. This angle is typically from zero to approximately ten degrees. A commonly employed angle is in the neighborhood of eight degrees. A purpose of introducing this angle to focusing lens 101 is to reduce back reflection. An example type of plano-convex lens commonly referred as the c-lens by many skilled in the art may be employed as focusing lens 101 according to this embodiment. First holder 103 is a glass tube according to this embodiment. Optical filter 102 is attached to the opposite end of first holder 103 with an adhesive in position, including the angular orientation of the normal to reflective surface 104. Optionally, the length of first holder 103 is chosen such that when the piano surface end of focusing lens 101 is in alignment with an end of first holder 103 and optical filter 102 is attached to the opposite end of first holder 103. Reflective surface 104 is substantially on the focal plane of focusing lens 101.

A method for fabricating an embodiment of the present invention including the embodiment shown in FIG. 1 comprises: positioning and securing focusing lens 101 at a predetermined position on first holder 103, then positioning and securing optical filter 102 at a predetermined position on first holder 103. An alternative method for fabricating an embodiment of the present invention comprises: positioning and securing optical filter 102 at a predetermined position on first holder 103, then positioning and securing focusing lens 101 at a predetermined position on first holder 103. Another alternative method for fabricating an embodiment of the present invention comprises: positioning focusing lens 101 and optical filter 102 at their respective predetermined positions on first holder 103, then securing focusing lens 101 and optical filter 102 at their respective predetermined positions on first holder 103.

For setting an embodiment of the present invention to within a predetermined center wavelength range requirement for a predetermined distance between input port 111 and the optical axis of focusing lens 101, the method for fabricating an embodiment of the present invention further comprises selecting an optical filter 102 from a group of one or more optical filters of different center wavelengths and a focusing lens 101 from a group of one or more focusing lenses of different focal length. The criterion for this selection is that the selection will result in an embodiment that satisfies a predetermined center wavelength requirement. This selection process typically employs, for example, an algorithm, a lookup table, a graph, a computer program, experience, or a combination thereof as an aid.

Table 1 is an example lookup table. It was compiled from the experimental data on focusing lenses 101 and optical filters 102. Focusing lens 101 and optical filter 102 employed for compiling Table 1 are a plano-convex lens and a type of bandpass thin film filter respectively. Many skilled in the art refer to this type of bandpass thin film filter as a wavelength division multiplexing (WDM) filter. Specifically, Table 1 is for matching a plano-convex lens to a 100 GHz bandwidth WDM filter with center wavelength between 1543.03 nm to 1543.58 nm to form an optical filter assembly that has center wavelength of 1542.94 nm±0.02 nm with the separation between input port 111 and output port 112 at 125 μm. The WDM filter wavelength in Table 1 is specified at zero degree incident angle. The 1542.94 nm wavelength is commonly known to one skilled in the art as ITU Channel 43 of a WDM system. Table 2 is another example lookup table and it is for a 100 GHz bandwidth WDM filters with center wavelength between 1560.70 nm to 1561.25 nm. Specifically, Table 2 is for matching a piano-convex lens to a 100 GHz bandwidth WDM filter with center wavelength between 1560.70 nm to 1561.25 nm to form an optical filter assembly that has center wavelength of 1560.61 nm±0.02 nm with the separation between input port 111 and output port 112 at 125 μm. The 1560.61 nm wavelength is commonly known to one skilled in the art as ITU Channel 21 of a WDM system.

An representative approach of applying the lookup tables is to pick a WDM filter and then use the lookup tables to look up the focal length of the focusing lens 101 to be assembled in the optical filter assembly with the WDM filter according to the center wavelength of the WDM filter and the ITU Channel number of the center wavelength of the finished optical filter assembly. For example, for a WDM filter with center wavelength of 1543.15 nm, using Table 1, matches with a focusing lens of 2.40 mm focal length and the resulted optical filter assembly is expected to center on ITU Channel 43 with +0.02 nm tolerance for a 125 μm separation between input port 111 and output port 112. An alternative approach of applying the lookup tables is to pick a focal length of focusing lens 101 in the lookup table and then use the lookup tables to look up the center wavelength range of the WDM filter to be assembled in the optical filter assembly with focusing lens 101 and the ITU Channel number of the center wavelength of the finished optical filter assembly.

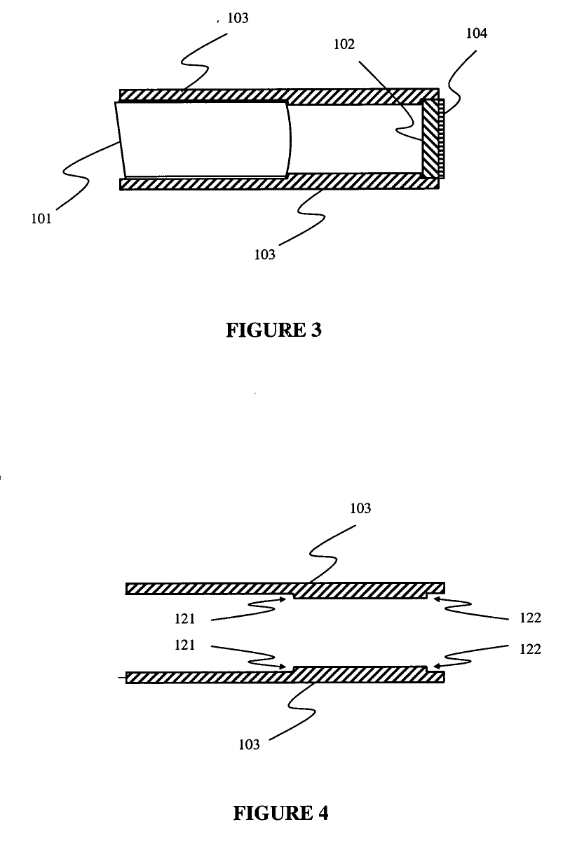

FIG. 3 shows the schematic of an alternative embodiment according to the present invention. FIG. 4 is a sectional view of a representative first holder 103 suitable for use in the embodiment shown in FIG. 3. Referring to FIG. 4, first holder 103 has non-uniform wall thickness. Further, first holder 103 has focusing lens seat 121 for receiving and positioning focusing lens 101 in a predetermined range of positions, and optical filter seat 122 for receiving and positioning optical filter 102 in a predetermined range of positions. Referring to FIG. 3, reflective surface 104 is facing away from focusing lens 101. First holder 103 is made from a material preferable to have a thermal expansion coefficient between approximately fifty percent and one hundred and fifty percent of the thermal expansion coefficient of focusing lens 101. An example of this material is the alloy with the trade name Kovar. Representative methods for attaching focusing lens 101 and filter 102 to first holder 103 include, for example, applying an adhesive, soldering or press fitting.

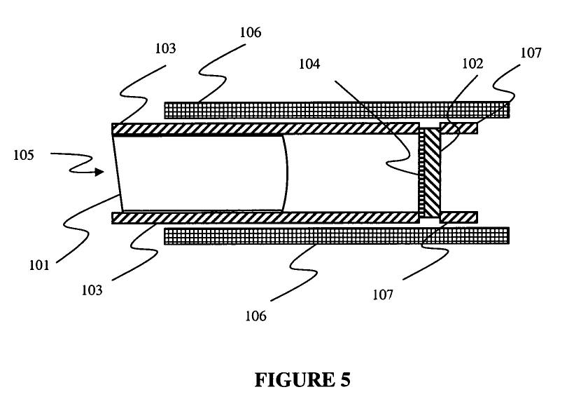

FIG. 5 shows the schematic of another alternative embodiment according to the present invention. Optical filter 102 attaches to stop member 107. Both first holder 103 and stop member 107 are in second holder 106 and attached to second holder 106. Optical filter 102 attaches indirectly to first holder 103 through second holder 106,
There are numerous variations to the embodiments discussed above which will be trivial to the one skilled in the art. Examples of these variations include but are not limited to:
Focusing lens 101 may have a anti-reflection coating;
Focusing lens 101 may comprise a double-convex lens;
Focusing lens 101 may comprise a concave-convex lens;
Focusing lens 101 may comprise a gradient index (GRIN) lens;
Focusing lens 101 may be a spherical lens;
Focusing lens 101 may be an aspherical lens;
Focusing lens 101 may be a compound lens with multiple lens element;
First holder 103 may be a semi-circular or U channel;
First holder 103 is not limited to a tube shape;
Besides transmissive optical filters and thin film filters, any optical reflector that has an optical characteristic dependent on the incident angle may be use for optical filter 102;
An example of optical filter 102 is an reflection grating;
Second holder 106 and stop member 107 may be fabricated as a single piece part;
Stop member 107 is optional and optical filter 102 is directly attached to second holder 106 in the embodiment shown in FIG. 5;
Stop member 107 is not limited to the tube shape shown in FIG. 5 and it may be a solid block;
Stop member 107 is an optical fiber collimator assembly and the optical fiber collimator assembly optically couples to focusing lens 101 through optical filter 102; (One skilled in the art readily understand that an optical fiber collimator assembly has at least one optical fiber extending from the optical fiber collimator assembly. The optical fiber collimator assembly optically couples a predetermined external collimated light beam with the light propagating in the optical fiber that extends from the optical fiber collimator assembly through the termination of this optical fiber that is inside the optical fiber collimator assembly.)
Stop member 107 is a part of an optical fiber collimator assembly;
Stop member 107 is a part of an optical fiber collimator assembly and the optical fiber collimator assembly optically couples to focusing lens 101 through optical filter 102;
Stop member 107 holds a collimating lens and the collimating lens optically couples to focusing lens 101 through optical filter 102, which allows light of selected wavelengths to pass through;
Example attachment methods include attaching with an adhesive, soldering, or press fitting; and
A combination or subcombination of any of the above.

Although the embodiment of the invention has been illustrated and that the form has been described, it is readily apparent to those skilled in the art that various modifications may be made therein without departing from the spirit of the invention.

TABLE 1

| | | Filter assembly center wavelength |
|---|---|---|
| Center wavelength of WDM | Focal length of plano- | at 125 μm separation between input |
| filter with 100 GHz bandwidth | convex focusing lens | port and output port |
| at 0 degree incident angle | (c-lens) | (±0.02 nm tolerance) |
| 1543.03 nm to 1543.08 nm | 3.31 mm | 1542.94 nm (ITU Channel 43) |
| 1543.08 nm to 1543.13 nm | 2.74 mm | 1542.94 nm (ITU Channel 43) |
| 1543.13 nm to 1543.18 nm | 2.40 mm | 1542.94 nm (ITU Channel 43) |
| 1543.18 nm to 1543.23 nm | 2.15 mm | 1542.94 nm (ITU Channel 43) |
| 1543.23 nm to 1543.28 nm | 1.97 mm | 1542.94 nm (ITU Channel 43) |
| 1543.28 nm to 1543.33 nm | 1.83 mm | 1542.94 nm (ITU Channel 43) |
| 1543.33 nm to 1543.38 nm | 1.71 mm | 1542.94 nm (ITU Channel 43) |
| 1543.38 nm to 1543.43 nm | 1.62 mm | 1542.94 nm (ITU Channel 43) |
| 1543.43 nm to 1543.48 nm | 1.54 mm | 1542.94 nm (ITU Channel 43) |
| 1543.48 nm to 1543.53 nm | 1.47 mm | 1542.94 nm (ITU Channel 43) |
| 1543.53 nm to 1543.58 nm | 1.40 mm | 1542.94 nm (ITU Channel 43) |

TABLE 2

| | | Filter assembly center wavelength |
|---|---|---|
| Center wavelength of WDM | Focal length of plano- | at 125 μm separation between input |
| filter with 100 GHz bandwidth | convex focusing lens | port and output port |
| at 0 degree incident angle | (c-lens) | (±0.02 nm tolerance) |
| 1560.70 nm to 1560.75 nm | 3.31 mm | 1560.61 nm (ITU Channel 21) |
| 1560.75 nm to 1560.80 nm | 2.74 mm | 1560.61 nm (ITU Channel 21) |
| 1560.80 nm to 1560.85 nm | 2.40 mm | 1560.61 nm (ITU Channel 21) |
| 1560.85 nm to 1560.90 nm | 2.15 mm | 1560.61 nm (ITU Channel 21) |
| 1560.90 nm to 1560.95 nm | 1.97 mm | 1560.61 nm (ITU Channel 21) |
| 1560.95 nm to 1561.00 nm | 1.83 mm | 1560.61 nm (ITU Channel 21) |
| 1561.00 nm to 1561.05 nm | 1.71 mm | 1560.61 nm (ITU Channel 21) |
| 1561.05 nm to 1561.10 nm | 1.62 mm | 1560.61 nm (ITU Channel 21) |
| 1561.10 nm to 1561.15 nm | 1.54 mm | 1560.61 nm (ITU Channel 21) |
| 1561.15 nm to 1561.20 nm | 1.47 mm | 1560.61 nm (ITU Channel 21) |
| 1561.20 nm to 1561.25 nm | 1.40 mm | 1560.61 nm (ITU Channel 21) |

1. An optical filter assembly, comprising:
a focusing lens;
a first holder holding said focusing lens substantially at a predetermined relative angular orientation with respect to said first holder; and
an optical filter having a reflective surface attaching to said first holder optically coupling with said focusing lens;
wherein:
said optical filter assembly is suitable for use in an optical fiber system; and
the optical filtering characteristic of said optical filter is a function of the incident angle of the light incident to said optical filter;
said optical attaches to said focusing lens through said first holder; and
said optical fiber assembly is suitable for setting the optical filtering characteristics of said optical filter assembly through selecting the focal length of said focusing lens

2. An optical filter assembly as claimed in claim 1, wherein, the normal to said reflective surface is substantially parallel to the optical axis of said focusing lens at the intersection of the optical axis of said focusing lens and said reflective surface.

3. An optical filter assembly as claimed in claim 1, wherein, said focusing lens is selected from a set consisting of plano-convex lens, double-convex lens, concave-convex lens, gradient index (GRIN) lens, spherical lens, aspherical lens, and compound lens with multiple lens elements.

4. An optical filter assembly as claimed in claim 1, wherein, said focusing lens comprises a plano-convex lens being disposed in said first holder so that the convex surface of said plan-convex lens is facing said optical filter.

5. An optical filter assembly as claimed in claim 4, wherein, said reflective surface is disposed substantially on the focal plane of said focusing lens at the intersection of the optical axis of said focusing lens and said reflective surface.

6. An optical filter assembly as claimed in claim 4, wherein, said the normal of the plano surface of said plano-convex lens is at an angle with respect to the optical axis of said plano-convex lens.

7. An optical filter assembly as claimed in claim 1 further comprises an optical fiber collimator attaching to said first holder optically coupling with said focusing lens through said optical filter.

8. An optical filter assembly as claimed in claim 7 further comprises a second holder through which said optical fiber collimator attaches to said first holder.

9. An optical filter assembly as claimed in claim 1 further comprises at least two optical fibers optical coupled through said focusing lens and said optical filter.

10. An optical filter assembly as claimed in claim 9 further comprises a fiber ferrule holding a termination of each of said optical fibers in position, said optical fibers attach to said first holder through said fiber ferrule.

11. An optical filter assembly as claimed in claim 10 further comprises an optical fiber collimator attaching to said first holder optically coupling with at least one of said optical fibers through said optical filter and said focusing lens.

12. An optical filter assembly as claimed in claim 11 further comprises a second holder through which said optical fiber collimator attaches to said first holder.

13. An optical filter assembly as claimed in claim 1, wherein, said first holder further comprises a focusing lens seat for receiving said focusing lens.

14. An optical filter assembly as claimed in claim 1, wherein, said first holder further comprises an optical filter seat for receiving said optical filter.

15. An optical filter assembly, comprising:
a focusing means;
a first holder means for holding said focusing means; and
an optical filter means for at least partially reflecting incident light having a reflective surface attaching to said first holder means optically coupling with said focusing means;
wherein:
said optical filter assembly is suitable for use in an optical fiber system;
the optical filtering characteristic of said optical filter means is a function of the incident angle of the light incident to said optical filter means; and
said optical fiber assembly is suitable for setting the optical filtering characteristics of said optical filter assembly through selecting the focal length of said focusing lens means.

16. An optical filter assembly as claimed in claim 15, wherein, the normal to said reflective surface is substantially parallel to the optical axis of said focusing means at the intersection of the optical axis of said focusing means and said reflective surface.

17. An optical filter assembly as claimed in claim 15, wherein, said focusing means is selected from a set consisting of plano-convex lens, double-convex lens, concave-convex lens, gradient index (GRIN) lens, spherical lens, aspherical lens, and compound lens with multiple lens elements.

18. An optical filter assembly as claimed in claim 15, wherein, said focusing means comprises a plano-convex lens disposed in said first holder so that the convex surface of said plano-convex lens is facing said optical filter means.

19. An optical filter assembly as claimed in claim 18, wherein, said reflective surface is substantially on the focal plane of said focusing means at the intersection of the optical axis of said focusing means and said reflective surface.

20. An optical filter assembly as claimed in claim 18, wherein, said the normal of the plano surface of said plano-convex lens is at an angle with respect to the optical axis of said plano-convex lens.

21. An optical filter assembly as claimed in claim 15 further comprises an optical fiber collimator means attaching to said first holder means for optically coupling said focusing means with an optically fiber extending from said optical fiber collimator means through said optical filter means.

22. An optical filter assembly as claimed in claim 21 further comprises a second holder means for attaching said optical fiber collimator means to said first holder means.

23. An optical filter assembly as claimed in claim 15 further comprises at least two optical fibers optical coupled through said focusing means and said optical filter means.

24. An optical filter assembly as claimed in claim 23 further comprises a fiber ferrule holding a termination of each of said optical fibers in position, said optical fibers attach to said first holder means through said fiber ferrule.

25. An optical filter assembly as claimed in claim 24 further comprises an optical fiber collimator means attaching to said first holder means for optically coupling at least one of said optical fibers to an optically fiber extending from said optical fiber collimator means through said optical filter means.

26. An optical filter assembly as claimed in claim 25 further comprises a second holder means for attaching said optical fiber collimator means to said first holder means.

27. A method for fabricating an optical filter assembly having at least a focusing lens, an optical filter, and a first holder, comprising:
positioning a first component selected from the group consisting of said focusing lens and said optical filter on said first holder at a first predetermined position corresponding to said first component with respect to said first holder;
securing said first component to said first holder;
positioning a second component selected from the group consisting of said focusing lens and said optical filter on said first holder at a second predetermined position corresponding to said second component with respect to said first holder; and
securing said second component to said first holder;
wherein, said optical filter assembly is suitable for use in an optical fiber system.

28. The method for fabricating an optical filter assembly as claimed in claim 27, further comprising:
selecting an optical filter from a group of at least one optical filter and a focusing lens from a group of at least one focusing lens so that the optical filter assembly that employs the selected optical filter and the selected focusing lens will satisfy a predetermined center wavelength range requirement measured under a predetermined measurement condition.

29. The method for fabricating an optical filter assembly as claimed in claim 28, further comprising:
attaching the ends of at least two optical fibers to said first holder through a fiber ferrule so that said optical fibers are optically coupled through said focusing lens and said optical filter.

30. The method for fabricating an optical filter assembly as claimed in claim 29, further comprising:
attaching an optical fiber collimator to said first holder so that at least one of said optical fibers is optically coupled with said optical fiber collimator through said optical filter and said focusing lens.

31. An optical filter assembly, comprising:
a first holder;
a plano-convex lens disposed in said first holder; and
an optical filter having a reflective surface attaching to said first holder optically coupling with said focusing lens;
wherein:
the convex surface of said piano-convex lens is facing said optical filter;
the normal of said reflective surface is substantially parallel to the optical axis of said piano-convex lens at the intersection of the optical axis of said piano-convex lens and said reflective surface;
said reflective surface is disposed substantially on the focal plane of said plano-convex lens at the intersection of the optical axis of said piano-convex lens and said reflective surface; and
said optical fiber assembly is suitable for setting the optical filtering characteristics of said optical filter assembly through selecting the focal length of said plano-convex lens.

32. An optical filter assembly as claimed in claim 31, wherein, said the normal of the plano surface of said plano-convex lens is at angle with respect to the optical axis of said plano-convex lens.

33. An optical filter assembly as claimed in claim 31, further comprising:
an optical fiber collimator attaching to said first holder optically coupling with said plano-convex lens through said optical filter; and
a second holder through which said optical fiber collimator indirectly attaches to said first holder.

34. An optical filter assembly as claimed in claim 31, further comprising:
at least two optical fibers optical coupled through said focusing lens and said optical filter; and
a fiber ferrule holding a termination of each of said optical fibers in position, said optical fibers attach to said first holder through said fiber ferrule.

35. An optical filter assembly as claimed in claim 34, further comprising:
an optical fiber collimator attaching to said first holder optically coupling with at least one of said optical fibers through said optical filter and said plano-convex lens; and
a second holder through which said optical fiber collimator indirectly attaches to said first holder.
